(19) United States
(12) Patent Application Publication
(10) Pub. No.: US 2021/0384628 A1
(43) Pub. Date: Dec. 9, 2021

(54) ULTRA WIDEBAND ANTENNA STRUCTURE

(71) Applicant: Mano Judd, Heath, TX (US)

(72) Inventor: Mano Judd, Heath, TX (US)

(21) Appl. No.: 16/895,690

(22) Filed: Jun. 8, 2020

(51) Int. Cl. H01Q 5/385; H01Q 1/36

(52) U.S. Cl. CPC H01Q 5/385; H01Q 1/36

(57) ABSTRACT

The new novelty employs the use of inductive grids or wire mesh structures as well as Electromagnetic Band Gap (EBG) structures, that generate antenna structures that become Electromagnetically transparent, as the antenna frequency is increased. As the frequency increases, these structures, which act as Band Pass Filters (BPF) start to become transparent and no longer absorb or reflect Electromagnetic Energy. Thus, the inner structure that is left, also acts as a BPF but with a higher frequency band. Therefore, the combined structures form an Antenna System with nearly a 5×5=25:1 frequency bandwidth or greater, with Gain above 0 dBi, omni directional pattern characteristics, and dominant radiation in the Antenna Broadside direction. Both or all structures share the same RF connector (1 port system), and in the case of a Dual Polarized Antenna System, they share two RF connectors (2 port system).

The present application claims priority to the earlier filed provisional application having Ser. No. 62/860,909, and hereby incorporates subject matter of the provisional application in its entirety.

### BACKGROUND

While many researchers have developed antennas that have very wide bandwidths, upwards of 3:1 frequency ratio to claims of 9:1 frequency ratio, the dominant problem is that as the antenna bandwidth reaches a threshold; normally at roughly a 5:1 frequency ratio, where the directivity or radiation pattern (directivity multiplied by efficiency) tends to form a null in the desired antenna transmit direction, which is termed the broadside direction. The inventor has solved this problem, and produces an antenna with upwards to 25:1 to over 100:1 bandwidth, with constant directivity in the broadside direction.

### BRIEF SUMMARY OF THE INVENTION

Exploits the Inventor's Patented Single Polarization and (patent Pending) Dual Polarization antenna structures, that achieve/enable wideband frequency operation with Absolute Broadside Pattern Gain better than +0 dBi across a 5:1 frequency bandwidth. These antenna structures are single layer (of metal or conductor) and can be completely conformal to a surface. Additionally, they produce very omni-directional radiation patterns across the full 5:1 frequency bandwidth, with maximum gain in the antenna broadside direction.

The new novelty employs the use of inductive grids or wire mesh structures as well as Electromagnetic Band Gap (EBG) structures, that generate antenna structures that become Electromagnetically transparent, as the frequency is increased.

These structures produce a larger antenna that operates at the lower frequency band. As the frequency increases, these structures, which act as Band Pass Filters (BPF) start to become transparent and no longer absorb or reflect Electromagnetic Energy. Thus, the inner structure that is left, also acts as a BPF but with a higher frequency band. Therefore, the combined structures form an Antenna System with nearly a 5×5=25:1 frequency bandwidth or greater, with Gain above 0 dBi, omni directional pattern characteristics, and dominant radiation in the Antenna Broadside direction.

Both or all structures share the same RF connector (1 port system). In the case of a Dual Polarized Antenna System, they share two RF connectors (2 port system).

### BRIEF DESCRIPTION OF THE DRAWINGS

FIG. 1 shows the Inventor's Patented (U.S. Pat. No. 9,954,280) Single Polarization Wideband Antenna Structure.

FIG. 2 illustrates the Inventor's patent Pending (application Ser. No. 15/210,583) Dual Polarization Wideband Antenna Structure.

FIG. 3 presents the operational constraints on both the systems of FIGS. 1 and 2.

FIG. 4 shows the mathematical development, which represents this lowest frequency in terms of the antenna maximum Length. L. and the speed of light, c.

FIG. 5 presents three charts of the Single Polarization (Structure) Dipole's radiation pattern, as a function of frequency.

FIG. 6 shows the Inventor's concept using two different surface structures.

FIG. 7 shows the new Gain and Pattern performance, as a function of operational frequency, for the new composite Ultra-Wideband Dipole antenna depicted in FIG. 6.

FIG. 8 shows the spectral coverage of the Antenna in FIG. 6.

FIG. 9 shows a similar Single Polarization Dipole to that of FIG. 6, however, in this case there are three different structural components [10a], [20a], [30a].

FIG. 10 shows one embodiment of the resulting Radiation Pattern results from FIG. 9.

FIG. 11 shows the Frequency versus Gain results from FIG. 9.

FIG. 12 shows one embodiment of a Dual Polarized Antenna Structure.

FIG. 13 shows new embodiments that include the EBG grid components developed into these structures.

FIG. 14 shows one of the embodiments from FIG. 13. placed into an Antenna Array System, Inventor's Provisional Patent No. 62/789,358.

FIG. 15 shows an additional embodiment of the overall concept, showing different mesh structures within a single (Single Pol or Dual Pol) leg.

FIG. 16 shows another embodiment of the overall concept, showing different mesh structures within a single (Single Pol or Dual Pol) leg.

FIG. 17 shows yet another embodiment of the overall concept, showing different mesh structures within a single (Single Pol or Dual Pol) leg.

FIG. 18 illustrates another embodiment of the overall concept, showing different mesh structures within a single (Single Pol or Dual Pol) leg.

### DETAILED DESCRIPTION AND BEST MODE OF IMPLEMENTATION

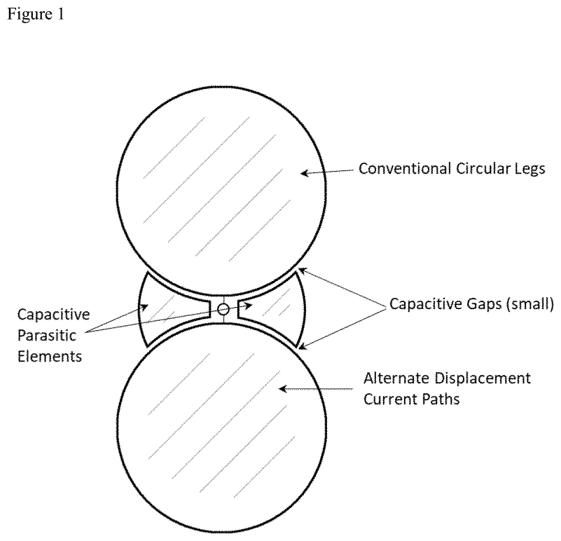

The Inventor's Patented (U.S. Pat. No. 9,954,280) Single Polarization Wideband Antenna Structure is shown in FIG. 1. This system utilizes a capacitive parasitic structure, on each side of the antenna with a (narrow) capacitive gap, to highly improve the Feed Impedance of the structure, as well as the Gain and pattern performance. The capacitive parasitics and gaps force the feed impedance to roughly 50 ohms (real) and near Zero Ohms (Reactive) across a full 5:1 frequency ratio, or bandwidth. This therefore provides an excellent match to a 50-ohm transmission line, at the feed, such as an RF coaxial cable.

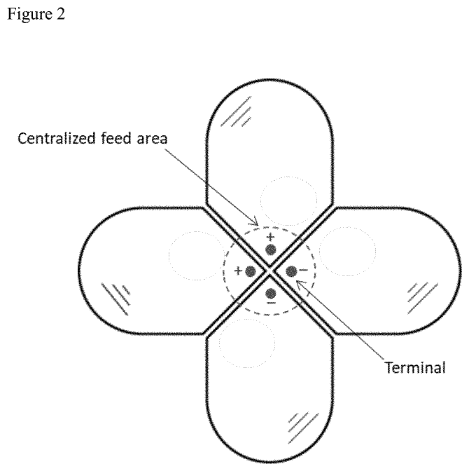

The Inventor's patent Pending (application Ser. No. 15/210,583) Dual Polarization Wideband Antenna Structure can be seen in FIG. 2. With this Structure. Orthogonal (Perpendicular) Antenna Legs become the Capacitive Parasitic structure to their Perpendicular Legs. Both of these Legs can actually operate simultaneously, radiating or receiving energy in dual polarizations, to each other, respectively. Similar to the Single Polarization Structure, this system utilizes this capacitive parasitic mechanism, and gaps, to highly improve the Feed Impedance of the structure, as well as the Gain and pattern performance for both polarizations. This Antenna system is symmetric and provides for two distinct feeds or connectors at the center.

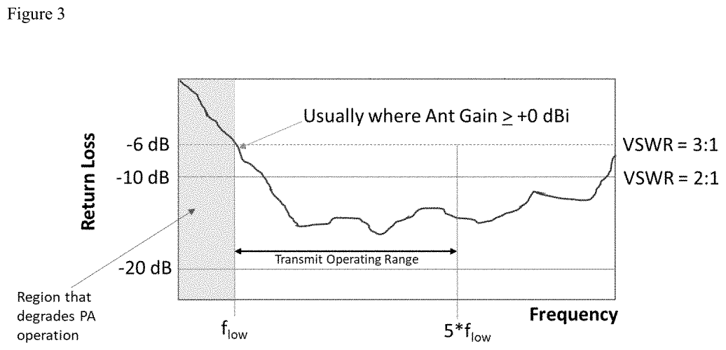

The operational constraints on both the systems of FIGS. 1 and 2 is shown in FIG. 3. The maximum size or length of each structure becomes roughly 0.3 times the wavelength associated with the lowest operational frequency of the system, where the Absolute Antenna Gain at Broadside, is greater than or equal to +0 dBi.

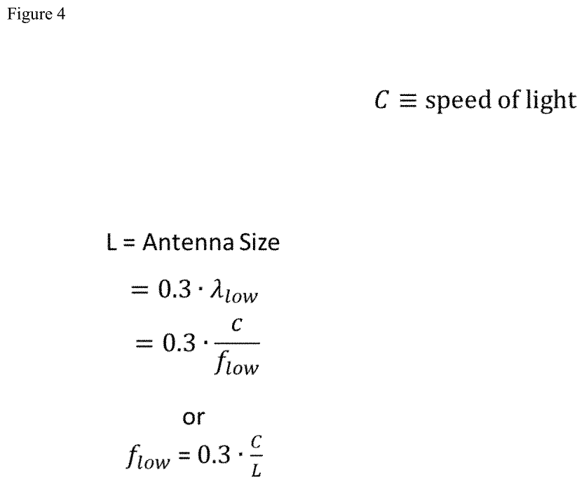

The mathematical development, which represents this lowest frequency in terms of the antenna maximum Length. L. and the speed of light, c is shown in FIG. 4. In many communities, such as IEEE, nominal Antenna Return Loss (RL) is specified as −10 dB, which is also a Voltage Standing Wave Ratio (VSWR) of 2:1. The metric is basically arbitrary, and is usually ignored by system engineers. The hard metric is usually a worst case return loss of −6 dB, or equivalently a VSWR of 3:1. It should be noted that antenna measurement in an anechoic chamber have verified that the minimal +0 dBi Absolute Gain, at Broadside to the single Polarization Wideband Dipole or Dual Polarization Wideband Dipole structure usually starts at the −6 dB Return Loss point. This frequency point is denoted as f_{low}. It has also been verified through measurements that as the Antenna Broadside Absolute Gain increases and then falls back to 0 dBi, that this point is normally at the frequency of 5 times f_{low}. On the left side of the chart in FIG. 3, f_{low}, is significant because it is the point where the system has Absolute Gain above 0 dBi, and a Return Loss better than −6 dB. The first metric, an Absolute Gain metric of 0 dBi is actually also an arbitrary value, however, a Return Loss worse than −6 dB can usually damage RF Power Amplifiers, preceding the antenna. This value of Return Loss is therefore not arbitrary, and becomes an important value in systems engineering of the overall design.

At roughly 5 times f_{low}, the E-Plane Radiation Pattern of the antenna will start to split. Thus gain in the Broadside pattern direction will start to fall below +0 dBi. This high frequency end or range therefore enables a good system operating range, for this antenna structure, of roughly 5:1. In the receive mode. RF power amplifiers are not used, and depending on the application, the antenna can usually operate far below +0 dBi with good performance or signal capture success suggesting a receive mode bandwidth far in excess of 5:1. Therefore, this 5:1 frequency operation range is often specified as the Transmit Operation Range for the system.

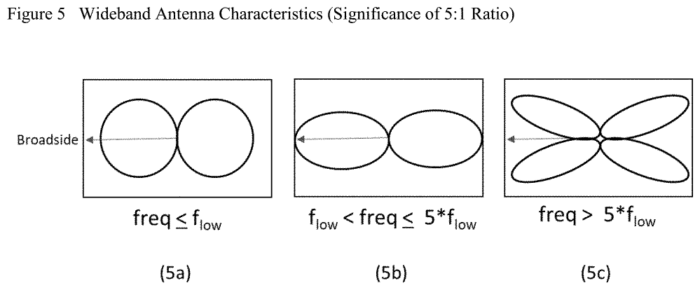

Three charts of the Single Polarization (Structure) Dipole's radiation pattern, as a function of frequency are presented in FIG. 5. Each of the three charts shows the effective E-Plane Dipole pattern, with the left side of each chart pointing to the Broadside direction. In FIG. 5a, where the operational frequency is equal to or lower than f_{b}w, the pattern is the quintessential “sliced donut” or dipole radiation pattern comprised of two adjacent circles. Even as the frequency goes much lower than f_{low}, the pattern (directivity) will be similar but the Gain (radius of each of the two circles) will be reduced. In FIG. 5b, for frequencies between f_{low}, and roughly 5 times f_{low}, the two circles are squeezed, which results in the Gain in the Broadside direction to increase.

This increase occurs to roughly a maximum at 2.5 times f_{low}. Above 2.5 times f_{low}, the Antenna Gain starts to reduce towards +0 dBi, at roughly 5 times f_{low}. What happens now at roughly 5 times f_{low} is that E-Plane radiation pattern splits and produces a narrow beam pointing upwards and a narrow beam pointing downward, shown in FIG. 5c. Additionally, in the Broadside direction, the gain obviously keeps decreasing to some minimal value, roughly around −6 to −10 dBi at around 10 times fl_{ow} (or a 10:1 frequency ratio). Past this frequency, the antenna gain then starts to increase again. The low side of frequency operation of the antenna is therefore based on reduced matching efficiency multiplied by reduced radiation efficiency, while on the high frequency side, around 5 times f_{low}, the antenna operation is limited by a split in the directivity or radiation pattern. It should be noted, that this high side characteristic reduces operation both for transmit and receive modes.

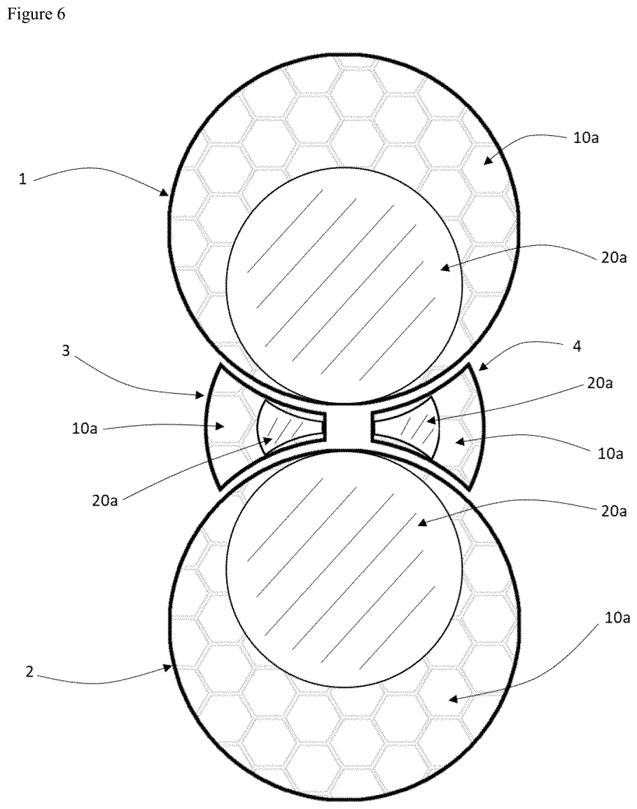

The Inventor's concept using two different surface structures can be seen in FIG. 6. The larger circular leg, one for each side of the wideband dipole, shows two different structures, [1] and [2], on each leg of the dipole. The first or top leg [1] is comprised of a combination of mesh (chickenwire) type material, of a single layer of metal (or copper). [10a]. The grid structure of this mesh is comprised of EBG structures. There are many different types of EBG structures that would operate well for this system, and are covered in the open literature. Please see references for example.

The first requirement for component [10a] is either that the filter characteristics for components of this structure either start at zero frequency, for a Low Filter Pass case, or at f_{low} for the Band Filter Pass case. One other requirement to this structure section [10a] is that the EBG mesh components must either form a Low Pass Filter (LPF) or Band Pass Filter (BPG), with the cut-off frequency of this filter just below 5 times f_{low}.

The structure of [20a] is on the same surface of [10a] and can be made of solid (layer) metal or it could be also made as an EBG mesh. Thus [10a] and [[20a] are both components of the top leg [1] and occupy the same metal layer. Similarly. [10a] and [[20a] are both components of the bottom leg [2] and occupy the same metal layer as well. However, for this structural component [20a], it must operate as a Band Pass Filter with high end cut-off frequency of roughly 25 times f_{low}.

Capacitive Parasitic elements must also be constructed with the same EBG mesh elements as [10a] and [20a]. Capacitive parasitic element [3] is composed of both structural mesh grids, with EBG roots, of both [10a] and [20a] structural components.

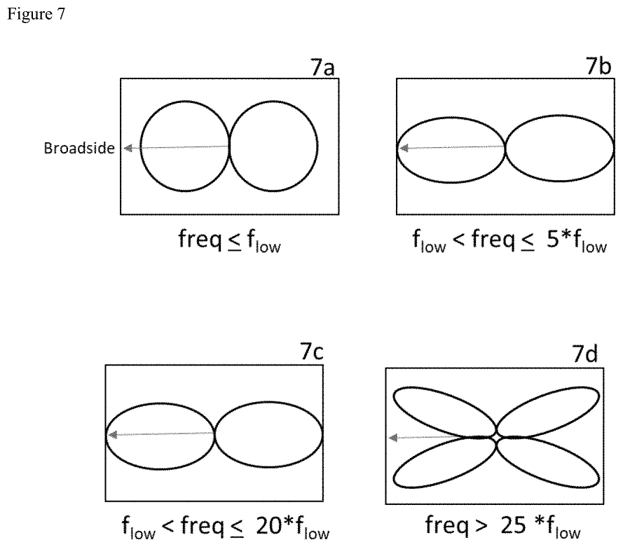

The new Gain and Pattern performance, as a function of operational frequency, for the new composite Ultra-Wideband Dipole antenna depicted in FIG. 6, is shown in FIG. 7.

Each of the four charts shows the effective E-Plane Dipole pattern, with the left side of each chart pointing to the Broadside direction. In FIG. 7a, where the operational frequency is equal to or lower than f_{low}, the pattern is the quintessential “sliced donut” or dipole radiation pattern comprised of two adjacent circles. Even as the frequency goes much lower than f_{low}, the pattern will be similar but the absolute Gain (radius of each of the two circles) will be reduced. In FIG. 7b, for frequencies between f_{low} and roughly 5 times f_{low}, the two circles are squeezed vertically, which results in the Gain in the Broadside direction to increase. This increase occurs to roughly a maximum at 2.5 times f_{low}. Above 2.5 times f_{low}, the Antenna gain starts to decrease towards +0 dBi, at roughly 5 times f_{low}. However, at roughly four to five times f_{low}, the outer material of [10a] starts to become RF transparent, and the inner material of [20a] becomes the primary radiating material. In FIG. 7c, for frequencies between 5 times f_{low} and roughly 20 to 25 times f_{low}, the inner radiation structural component of [20a] acts as it alone is only absorbing or radiating energy, since [10a] is now RF transparent. With [10a] as transparent, the component structure of [20a] operates as an antenna, roughly 5 times smaller size than [1] and [2] combined, yet still with an effective bandwidth ratio of 5:1. What happens now at roughly 20 to 25 times f_{low} is that E-Plane radiation pattern finally splits and produces a narrow beam pointing upwards and a narrow beam pointing downward, shown in FIG. 7d. Since both structures of [10a] and [20a] share the same RF connector at the center (not shown), the effective antenna bandwidth, for broadside radiation, of the whole antenna system has been increased from 5:1 to 25:1.

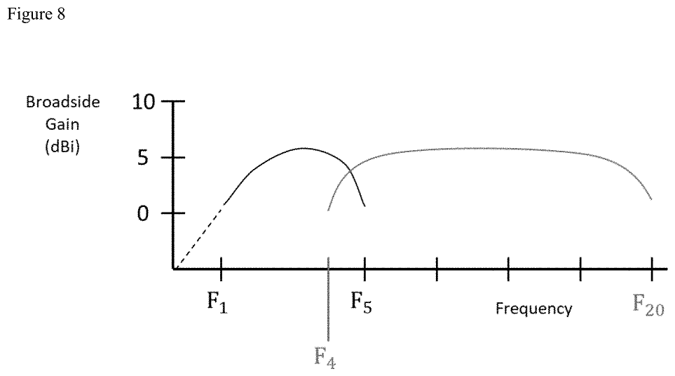

The spectral coverage of the Antenna in FIG. 6 is shown in FIG. 8. From frequency F1 to roughly F5 (five times F1), the Full Antenna Structure would have Broadside Gain above 0 dBi. However, as the [10a] Component becomes RF Transparent, the second Component [20a] becomes the sole radiating/receiving structure, and enables Absolute Broadside Gain from roughly frequency F4 (4 times F1) to F20 (20 times F1). Note in this diagram. F1 is the same as f_{low}. By changing the dimensions of the inner Structural component, we can alter the low and high frequencies of operation. That is, by making the inner component structure [20a] smaller, or less in diameter, we can raise its coverage to F5 (five times F1) to F25 (25 times F1]. Therefore, the Full Antenna would have Broadside Gain, greater than +0 dBi, from F1 to 25 times F1.

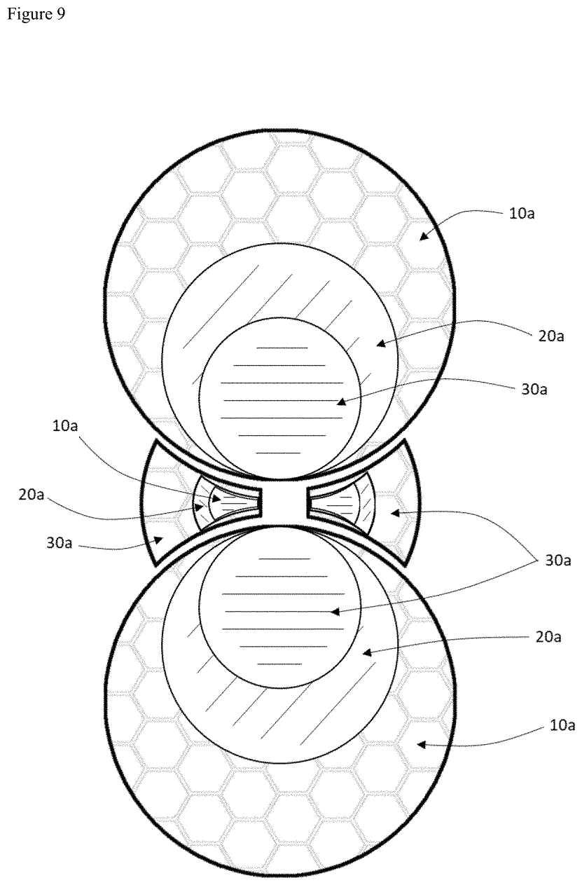

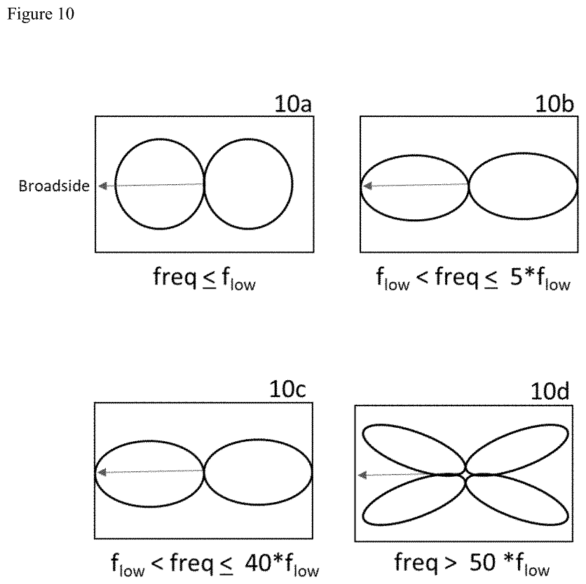

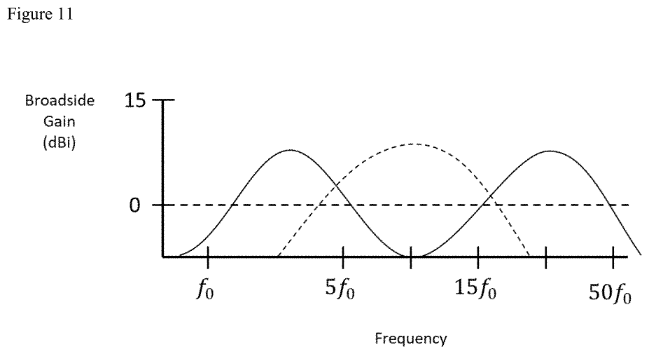

The Single Polarization Dipole in FIG. 9 is similar to that of FIG. 6, however, in this case there are three different structural components [10a]. [20a]. [30a]. All three of these structural components are comprised of three different EBG mesh structures, each with their own frequency range of operation. The most outer component [10a] operates from f_{low} to 5 times f_{low}, the second (inner) structural component [20a] operates from 5 times f_{low} to 25 times f_{low}, and the third structural component [30a] can operate from 25 times f_{low} to 125 times f_{low}. Each of these three structures operate using EBG components operating as effective Band Pass Filters, with different center band frequencies. Note, the frequency ranges of operation can be flexible, and be designed for almost any range of sub-frequency operation. For example, another embodiment of this design could have the most outer component operates from f_{low} to 5 times f_{low}, the second (inner) structural component operates from 4 times f_{low} to 20 times f_{low}, and the third structural component operates from 15 times f_{low} to 50 times f_{low}. This would result in the Radiation Pattern results shown in FIG. 10 and the Frequency versus Gain response of FIG. 11. It should be noted that the Capacitive Parasitic structures would also share the same three band pass structure components of EBG mesh.

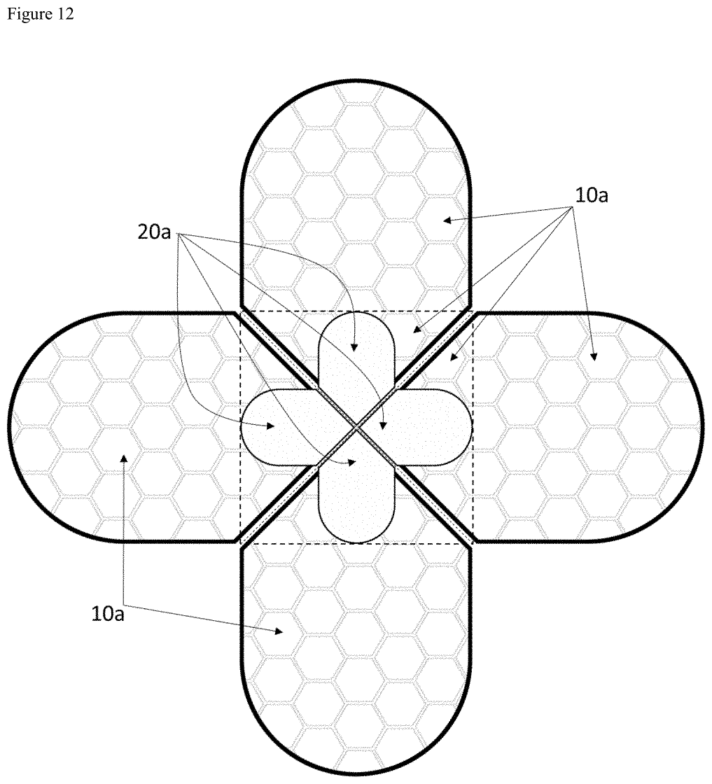

One embodiment of a Dual Polarized Antenna Structure is shown in FIG. 12. Here again. Structure Components in the outer sections of each Leg are comprised of EBG Grids [10a], and the Inner section as EBG Grids of [20a]. Bandwidth and operation of each Cross Dipole Leg would be similar to the results in FIGS. 7 and 8.

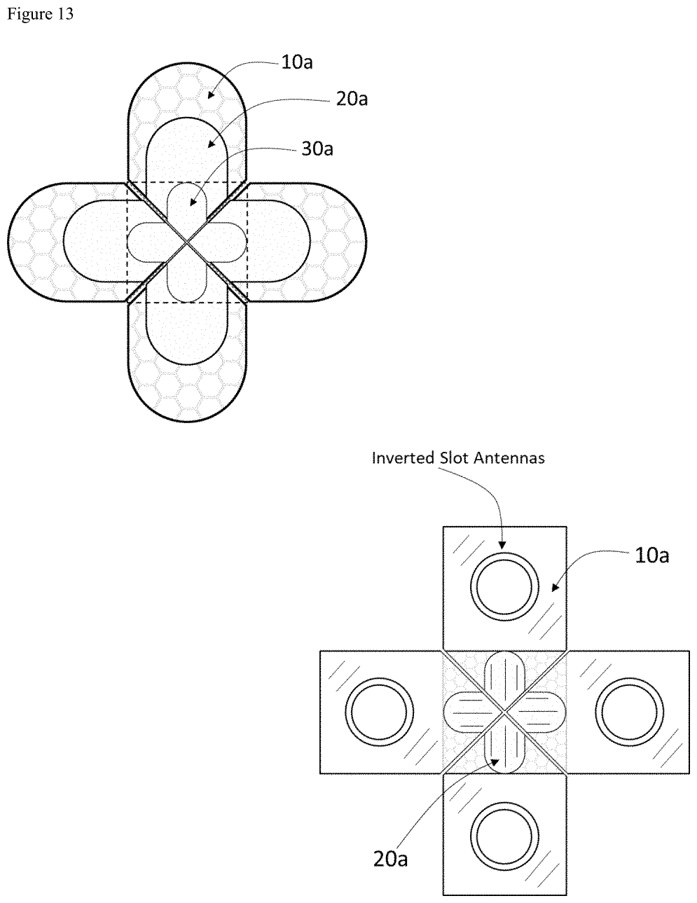

FIG. 13 shows new embodiments that include the EBG grid components developed into these structures. This would enable the lower frequency components to have very extended frequency coverage by 5× to 25× times. The Applicant has submitted other patents which include a Broadband array designed with the dual polarized cross dipole antenna (62/789,358) as well as Inverted Slot Antennas (62/744,995).

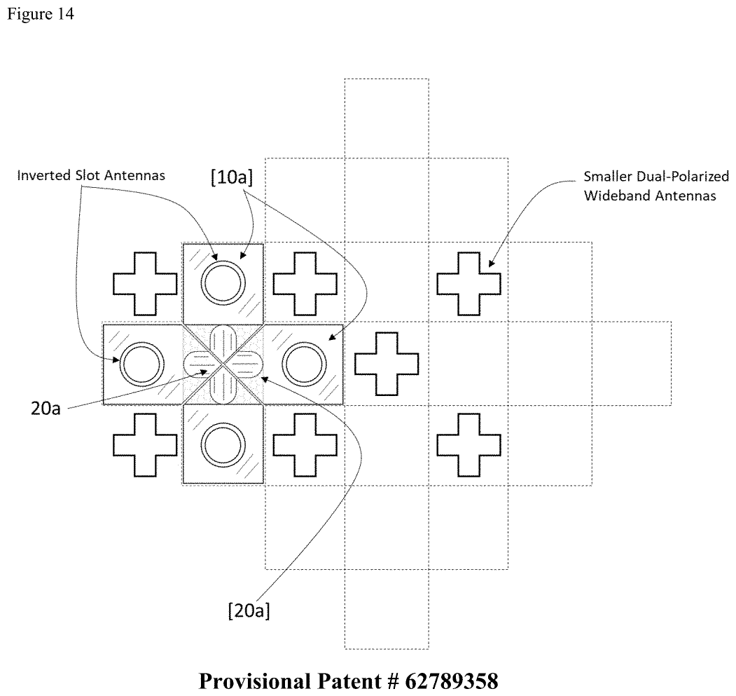

FIG. 14 shows one embodiment from FIG. 13, placed into an array system. This would enable the lower frequency components to have very extended frequency coverage by 5× to 25× times. This is explained in more detail, in the Inventor's Wideband Dual Pole Antenna Array System. Provisional Patent No. 62/789,358.

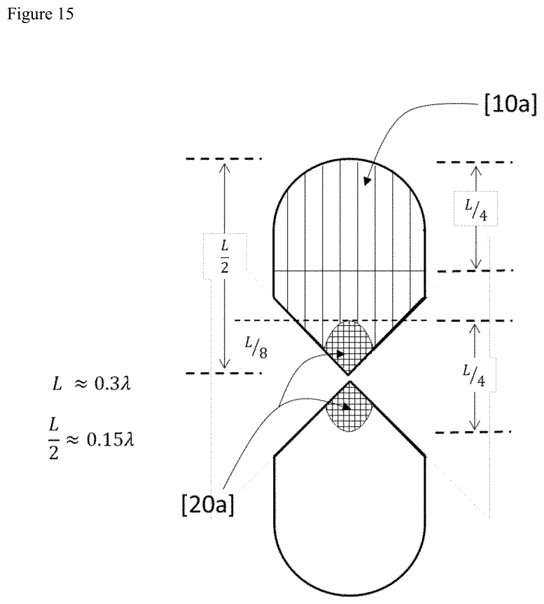

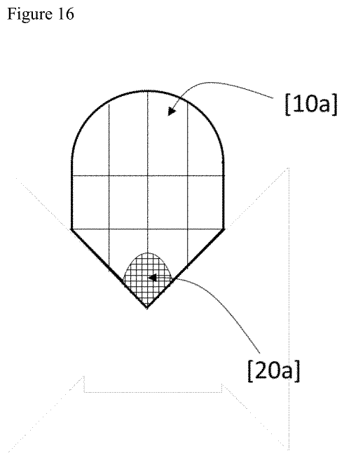

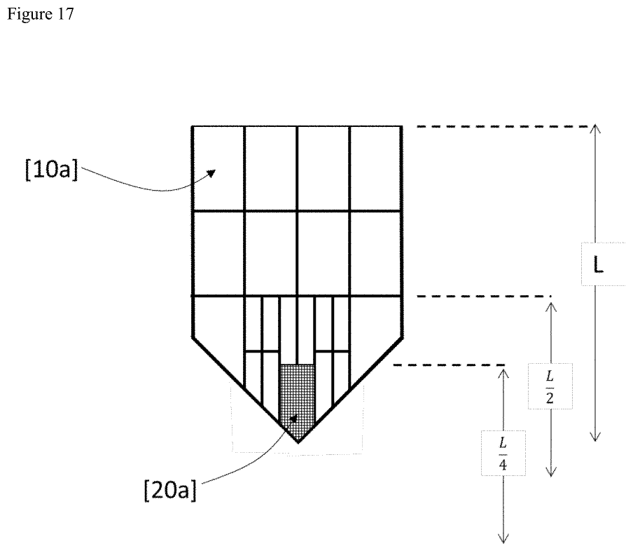

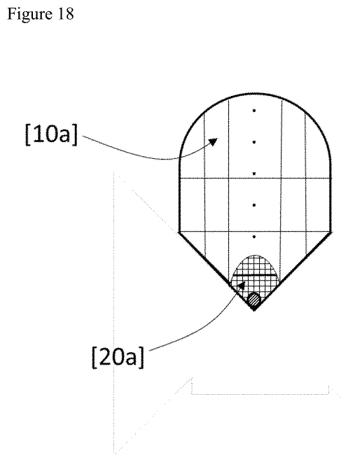

FIGS. 15 through 18 all show additional embodiments of the overall concept, showing different mesh structures within a single (Single Pol or Dual Pol) leg. These structures would have a different frequency coverage benefits as well as polarization isolation benefits.

### REFERENCES (INCORPORATED HEREIN BY REFERENCE)

Sridhar Raja. D, Periodic EBG Structure based UWB Band Pass Filter, International Journal of Advanced Research in Electrical. Electronics and Instrumentation Engineering. ISSN: 2278-8875, pp 1682-1686, Vol. 2. Issue 5, May 2013.

What is claimed is:

1. An antenna comprising:
a plurality of conductive materials on the same surface, formed around a common feed port for a single polarization version, or two feed ports for a dual polarization version,
whereas the outermost surface components are composed of electromagnetic band gap structures, and said outermost structures become electromagnetically transparent as the frequency is increased;
an inner structure composed of metal, but is not an electromagnetic band gap structure;
whereas the inner and outer structures are approximately scaled in size to one another, and each form an antenna with shape and dimensions described in the single polarization version in U.S. Pat. No. 9,954,280 or the dual polarization version in U.S. Pat. No. 10,389,015; and
wherein the total of all components are conformal to a single surface.

2. The antenna of claim 1 wherein the individual structures combine to produce a larger antenna that operates at the lower frequency band, in which as the frequency increases, the outer structures act as band pass filters and start to become transparent and no longer absorbs or reflects electromagnetic energy.

3. The antenna of claim 1 wherein the electromagnetic band gap components operate as effective band pass filters or low pass filters with different center band frequencies and flexible frequency ranges of operation.

4. The antenna of claim 1 wherein the combined structures form an antenna system with nearly a 5×5=25:1 frequency bandwidth or greater, with absolute gain above 0 dBi, omni directional pattern characteristics, and dominant radiation in the antenna broadside direction.

5. The antenna of claim 1 whereas the dual polarized antenna system shares two RF connectors creating a 2 port system.

6. The antenna of claim 1 wherein a capacitive parasitic structure is utilized on each side of the antenna with a narrow capacitive gap, to highly improve the feed impedance of the structure, as well as the gain and pattern performance, as specified in the Inventor's Patented (U.S. Pat. No. 9,954,280) Single Polarization Wideband Antenna Structure.

7. The antenna of claim 1 wherein multiple surface structures are used in the leg of each antenna, and the outermost structures are comprised of a mesh type material on a single layer of conductive material, such as metal.

8. The antenna of claim 1 whereas the grid structure of the outermost mesh is comprised of electromagnetic band gap structures which must either form a low pass filter, with the cut-off frequency of this filter just below 5 times f_{low}, where f_{low} is the lowest operating frequency of the antenna system and wherein above 5 times f_{low}, in frequency, this structure then becomes electromagnetically transparent.

9. The antenna of claim 1 wherein the most inner structure will always be a non-electromagnetic band gap structure either as solid metal or conductor or a mesh conductor.

10. The antenna of claim 1 wherein for greater than 25:1 operation, there will be another inner electromagnetic band gap structure component, which operates as a band pass filter below 5 times f_{low} in frequency, but then operates as a low pass filter from 5 times f_{low}, to approximately 25 times f_{low}, therefore becoming electromagnetically transparent from above 25 times f_{low}.

11. The antenna of claim 1 whereas the most inner structure will always be a non-electromagnetic band gap structure either as solid metal or conductor or a mesh conductor, wherein the most outer component operates from f_{low} to 5 times f_{low}, the second (inner) structural component operates from 5 times f_{low} to 25 times f_{low}, and the third, or most inner, structural component can operate from 25 times f_{low} to 125 times f_{low}.

12. The antenna of claim 1 wherein the inner structures consist of capacitive parasitic elements which must also be constructed with the same electromagnetic band gap mesh elements as the outer structures and in the same frequency ranges.

13. The antenna of claim 1 comprising a dual polarized antenna structure consisting of two similar cross dipole legs, each containing outer electromagnetic band gap structural components that become electromagnetically transparent as the frequency is increased, and containing capacitive parasitic elements, constructed with similar electromagnetic band gap structural elements as the antenna legs, which operate in similar frequency fashion and have outer shapes and form as described in U.S. Pat. No. 10,389,015.

14. A method of constructing an antenna comprising:
providing a plurality of conductive materials on the same surface, formed around a common feed port for a single polarization version, or two feed ports for a dual polarization version,
whereas the outermost surface components are composed of electromagnetic band gap structures, and said outermost structures become electromagnetically transparent as the frequency is increased;
providing an inner structure composed of metal, but is not an electromagnetic band gap structure;
whereas the inner and outer structures are approximately scaled in size to one another, and each form an antenna with shape and dimensions described in the single polarization version in U.S. Pat. No. 9,954,280 or the dual polarization version in U.S. Pat. No. 10,389,015; and
wherein the total of all components are conformal to a single surface.

15. The method of claim 14 wherein the individual structures combine to produce a larger antenna that operates at the lower frequency band, in which as the frequency increases, the outer structures act as band pass filters and start to become transparent and no longer absorb or reflect electromagnetic energy.

16. The method of claim 14 wherein the electromagnetic band gap components operate as effective band pass filters or low pass filters with different center band frequencies and flexible frequency ranges of operation.

17. The method of claim 14 wherein the combined structures form an antenna system with nearly a 5×5=25:1 frequency bandwidth or greater, with Gain above 0 dBi, omni directional pattern characteristics, and dominant radiation in the antenna broadside direction.

18. The method of claim 14 wherein the dual polarized antenna system shares two RF connectors creating a 2 port system.

19. The method of claim 14 wherein a capacitive parasitic structure is utilized on each side of the antenna with a narrow capacitive gap, to highly improve the feed impedance of the structure, as well as the gain and pattern performance, as specified in the Inventor's Patented (U.S. Pat. No. 9,954,280) Single Polarization Wideband Antenna Structure.

20. The method of claim 14 wherein multiple surface structures are used in the leg of each antenna, and the outermost structures are comprised of a mesh type material on a single layer of conductive material, such as metal.

21. The method of claim 14 whereas the grid structure of the outermost mesh is comprised of electromagnetic band gap structures which must either form a low pass filter, with the cut-off frequency of this filter just below 5 times f_{low}, where f_{low} is the lowest operating frequency of the antenna system and wherein above 5 times f_{low}, in frequency, this structure then becomes electromagnetically transparent.

22. The method of claim 14 wherein the most inner structure will always be a non-electromagnetic band gap structure either as solid metal or conductor or a mesh conductor.

23. The method of claim 14 wherein for greater than 25:1 operation, there will be another inner electromagnetic band gap structure component, which operates as a band pass filter below 5 times f_{low}, but then operates as a low pass filter from 5 times f_{low}, to approximately 25 times f_{low}, therefore becoming electromagnetically transparent from above 25 times f_{low}.

24. The method of claim 14 whereas the most inner structure will always be a non-electromagnetic band gap structure either as solid metal or conductor or a mesh conductor, wherein the most outer component operates from f_{low} to 5 times f_{low}, the second (inner) structural component operates from 5 times f_{low} to 25 times f_{low}, and the third, or most inner, structural component can operate from 25 times f_{low} to 125 times f_{low}.

25. The method of claim 14 wherein the inner structures consist of capacitive parasitic elements which must also be constructed with the same electromagnetic band gap mesh elements as the outer structures and in the same frequency ranges.

26. The method of claim 14 comprising a dual polarized antenna structure consisting of two similar cross dipole legs, each containing outer electromagnetic band gap structural components that become electromagnetically transparent as the frequency is increased, and containing capacitive parasitic elements, constructed with similar electromagnetic band gap structural elements as the antenna legs, which operate in similar frequency fashion and have outer shapes and form as described in U.S. Pat. No. 10,389,015.
